(19) United States
(12) Patent Application Publication
(10) Pub. No.: US 2008/0053913 A1
(43) Pub. Date: Mar. 6, 2008

(54) Nutrient recovery process

(76) Inventor: Alexander G. Fassbender, Hudson, MA (US)

Correspondence Address: Kyla D. Cummings;Speed Law Firm, Suite 1200, 111 Center Street, North Little Rock, AK, 72201, US

(21) Appl. No.: 11/517,217

(22) Filed: Sep. 6, 2006

(51) Int. Cl. C02F 1/52

(52) U.S. Cl. 210/702; 210/202; 210/903

(57) ABSTRACT

Embodiments include a method and apparatus for cost-effective and efficient nutrient recovery from a waste stream. The nutrients recovered may include ammonia, phosphorous, and/or potassium. The ammonia and phosphorous recovery may be simultaneously accomplished. In some embodiments, ammonia is recovered along with other nutrients using lime or lime-based products.

### CROSS-REFERENCE TO RELATED APPLICATIONS

This application is a continuation-in-part of co-pending U.S. patent application entitled “Ammonia Recovery Process” filed by the present inventor, Alexander G. Fassbender, on Sep. 6, 2006 with the attorney docket number of THRM/0006, which patent application is herein incorporated by reference in its entirety.

### BACKGROUND OF THE INVENTION

1. Field of the Invention

Embodiments generally relate to a nutrient recovery process. More particularly, embodiments relate to a process for recovering ammonia from waste streams.

2. Description of the Related Art

Waste streams contain several components which it is desirable to separate from the waste streams and from one another, either for recovery of the components for later use or to prevent release of the components or combinations of the components to the environment. These waste streams may result from anaerobic digestion of sewage or animal wastes, from industrial processes such as rendering operations, and from coke and chemical manufacture.

Some of the components which are useful to separate from the waste stream are phosphorous, potassium, alkali earth metals, and ammonia. Anaerobically digested sewage sludge and animal wastes may be separated into a solids-rich stream and a solids-depleted stream, where the solids-depleted stream contains the bulk of the water as well as a variety of chemicals dissolved and suspended in the water. The suspended chemicals in the solids-depleted stream typically include ammonia nitrogen (NH₃—N) having a typical concentration ranging from 800 parts per million (ppm) to 8,000 ppm, hardness in the form of calcium carbonate with a typical concentration ranging from 50 ppm to 350 ppm, phosphate having a typical range of concentration from 2 ppm to 150 ppm, and total suspended solids having a typical concentration range of 500 ppm to 2,000 ppm.

Alkali earth salts dissolved in the solids-depleted stream are sometimes removed by cation exchange. Cation exchange treatment outputs a spent brine stream which typically contains a high quantity of sodium. The discharge of high quantities of sodium can be disadvantageous, especially in applications where the water will be discharged into fresh water or applied to soils. There is therefore a need for an effective and efficient nutrient recovery process which is acceptable for fresh water applications or where the water is applied to soils. There is also a need for an effective and efficient nutrient recovery process which is acceptable in either fresh water applications or salt water applications, or where water is applied to soils or otherwise released to the environment.

For these fresh water applications and where the water is applied to soils, another nutrient recovery process is sometimes utilized. This nutrient recovery process involves mixing the waste water with lime to precipitate calcium carbonate, which is highly insoluble in water, into a solid. The challenge of using lime-based products is that calcium hydroxide is only sparingly soluble in water and must dissolve before the reactions necessary to cause precipitation can occur. General approaches to remedy this problem exist, but the approaches are directed solely to removal of alkali earth metals and phosphorous and make no provision for ammonia removal. A method and apparatus are needed for removing ammonia along with the other nutrients which is acceptable for salt water, soil, and fresh water applications. A method and apparatus for simultaneously removing ammonia along with the other nutrients is needed.

### SUMMARY OF THE INVENTION

It is therefore an object of embodiments of the present invention to provide an effective and efficient nutrient recovery process which is acceptable for fresh water applications or where the water is applied to soils.

It is also an object of embodiments to provide an effective and efficient nutrient recovery process which is acceptable in either fresh water applications or salt water applications, or where water is applied to soils or otherwise released to the environment.

It is a further object of embodiments to provide a nutrient recovery process which is cost-effective.

It is also an object of embodiments to provide a nutrient recovery process using lime which is capable of effectively removing ammonia from a waste stream.

It is yet a further object of embodiments to provide a nutrient recovery process which is capable of effectively and efficiently removing ammonia along with other nutrients from a waste stream.

Another object of embodiments is to provide a nutrient recovery process which is capable of removing ammonia and other nutrients simultaneously from a waste stream.

Yet another object of embodiments is to provide apparatus for accomplishing the above nutrient recovery processes.

Toward fulfillment of these and other objects and advantages, embodiments include a method of recovering ammonia and precipitating phosphorous from a waste stream, comprising separating an anaerobically digested waste stream into a solids-rich stream and an solids-depleted stream; reacting the solids-depleted stream with lime or a lime-based solution to form a first mixture; introducing compressed gas into the first mixture to form an aerated first mixture; passing the aerated first mixture through a reaction zone; passing the aerated first mixture stream through a flocculation zone, where a flocculation agent is added to the aerated first mixture to form a second mixture; passing the second mixture stream through a settling zone, thereby removing precipitated settled solids from the second mixture stream and removing an ammonia-laden gas and a softened solids-depleted stream from the second mixture stream via sparged compressed gas; scrubbing the ammonia-laden gas using an acidic solution to remove ammonia therefrom; and passing at least a portion of the softened solids-depleted stream through at least one ammonia absorption column to remove ammonia therefrom, wherein introducing the compressed gas into the first mixture removes ammonia and enhances phosphorous precipitation. Embodiments further include an apparatus for removing ammonia and phosphorous from a waste stream, comprising a reacting and settling vessel comprising at least one reaction chamber for reacting a lime or lime-based product with a solids-depleted stream, at least one flocculation chamber for adding a flocculating agent to the solids-depleted stream, at least one settling chamber for settling and precipitating a solids stream from an ammonia-laden gas, and a capability to recirculate at least a portion of settled solids back to the at least one reaction chamber; at least one gas compressor for compressing a gas prior to its introduction into the at least one reaction chamber; and at least one ammonia absorption column for separating ammonia from the compressed gas subsequent to its contact in at least one of the chambers of the reacting and settling vessel, wherein the compressed gas removes ammonia from the solids-depleted stream and enhances phosphorous precipitation. Further embodiments include a method for slow softening a waste stream having soluble calcium compounds present therein, wherein at least one alkaline precipitating agent is admixed with the waste stream to be softened in a mixing zone and then the calcium compounds are changed inside a reaction zone through which the waste stream passes after being admixed with the alkaline precipitating agent into insoluble calcium carbonate matter which is subsequently changed in a flocculation zone into settleable flocs by the addition of a flocculating agent containing trivalent metal ions, comprising mixing the waste stream, the alkaline precipitating agent, and an agitated liquid, gas, or combination of liquid and gas with finely divided crystalline calcium carbonate in the mixing zone prior to the addition of and in the absence of the flocculation agent to form seeds for the calcium carbonate matter which newly precipitates from the waste stream inside the reaction zone; presettling and discharging at least a part of the insoluble calcium carbonate matter which has been precipitated inside the reaction zone; passing the waste stream into a flocculating zone, wherein the waste stream is mixed with the flocculating agent; and passing the waste stream into a sedimentation zone.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart of an embodiment of a nutrient recovery process.

### DETAILED DESCRIPTION

Embodiments of the present invention include a method and device for simultaneously, efficiently, and cost-effectively removing ammonia and phosphorous from waste water. The nutrient recovery process and system of some embodiments involves using calcium hydroxide or calcium oxide to raise stream pH, soften and precipitate phosphorous, and recover ammonia and/or potassium. Useful and valuable quantities of ammonia are recovered from a waste stream or landfill leachate by use of processes and equipment of embodiments. The waste stream may result from any process known to those skilled in the art which generates waste containing ammonia or the precursors to ammonia (nitrogen-containing wastes), including but not limited to streams from anaerobic digestion of sewage or animal wastes or streams from industrial processes such as rendering operations and coke and chemical manufacturing processes.

If present, phosphorous may also be precipitated and recovered from the waste stream along with the recovery of the ammonia. Therefore, embodiments of the present invention advantageously allow concurrent and effective removal of ammonia, phosphorus, and possibly other nutrients. Processes and devices of embodiments cost-effectively and efficiently enhance phosphorous recovery while allowing for recovery of ammonia from the waste stream. In embodiments, a lime sludge forms to allow precipitation of the phosphorous and other solids.

Embodiments include providing front end treatment of a waste stream using a lime product in a lime softener reactor and settler and introducing agitated gas (gas bubbles), such as air or carbon dioxide, into the waste stream to efficiently and effectively recover ammonia and potassium and precipitate phosphorus. In one embodiment, the gas bubbles are introduced into the lime softener reactor and settler while mixing the lime and waste stream, thereby enhancing precipitation of phosphorus as well as recovering ammonia-laden gas while mixing the lime and waste stream. Therefore, introducing the gas bubbles into the lime softener reactor and settler not only removes ammonia from the waste stream, but also causes improved precipitation of the phosphorous (improved in relation to the precipitation of phosphorous that occurs when only the lime softener reactor and settler are utilized without the gas bubbles).

Further embodiments provide front end treatment of the waste stream using the lime product in the lime softener reactor and settler and vacuum stripping the ammonia from the reacted and settled stream (e.g., using a vacuum stripper/stripping unit or a vacuum distillation unit) to efficiently recover ammonia from the waste stream. This embodiment may also include introducing the agitated gas (gas bubbles) into the lime softener reactor and settler prior to the vacuum stripping of the ammonia (e.g., while mixing the lime product and the waste stream). In embodiments of the present invention, lime is utilized in a solid/liquid system to recover ammonia from a waste stream, the system being calcium-based.

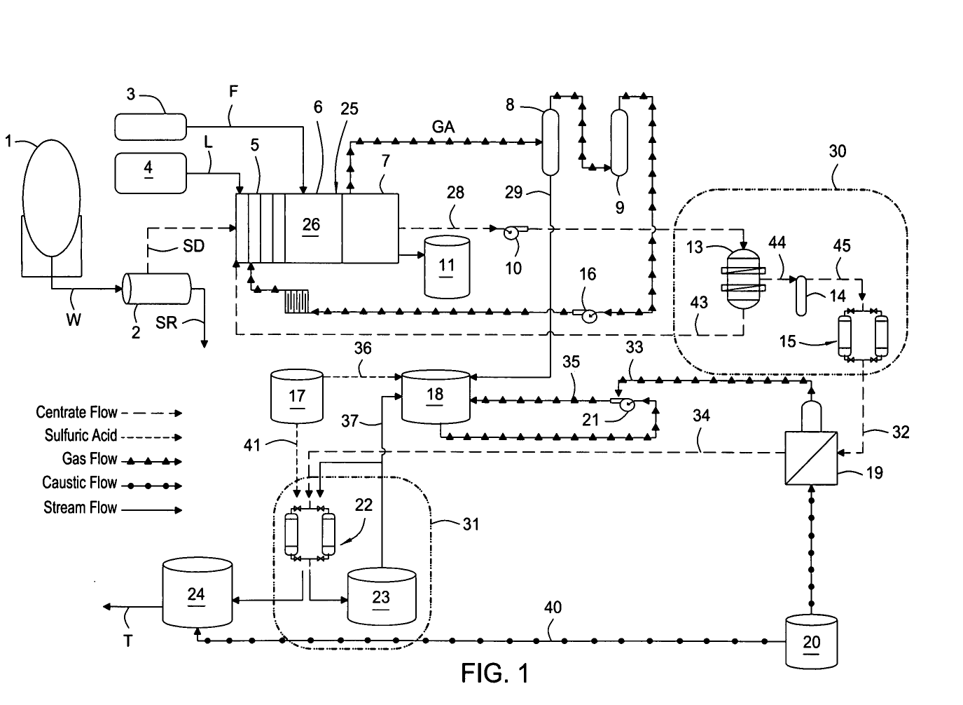

FIG. 1 shows an embodiment of a nutrient recovery process. In this embodiment, useful and valuable quantities of ammonia and/or phosphorous are recovered from a waste stream using various processes and equipment. The waste stream, which may include for example sewage sludge or animal wastes (but may also include waste resulting from industrial processes such as rendering operations or from coke or chemical manufacture), is anaerobically digested by an anaerobic digester 1 to produce a digested sludge or waste stream W. This digested waste stream W typically has an at least substantially neutral pH value (a pH of approximately 7). The digested sludge W is then separated into a solids-rich stream SR and a solids-depleted stream SD. The digested sludge W may be separated into these streams SD and SR by one or more separating devices 2, which may include one or more of any separating devices known to those skilled in the art, including but not limited to one or more centrifuges, filter presses, and/or settling basins.

The solids-depleted stream SD contains the bulk of the water as well as a variety of chemicals dissolved and suspended in the water, the dissolved and suspended chemicals typically including ammonia nitrogen (NH₃—N), calcium carbonate (CaCO₃) as the hardness, phosphate, and suspended solids. Some typical concentration ranges of these chemicals dissolved and suspended in the water are shown in Table 1 below:

TABLE 1

| | Typical Concentration Range (End values |
|---|---|
| Constituent | of ranges are approximate) |
| ammonia nitrogen | 400–16,000 parts per million (ppm), |
| | or 800–8,000 ppm |
| calcium carbonate | 50–350 ppm |
| phosphate | 2–150 ppm |
| total suspended solids | 500–2,000 ppm |

Of course, the solids-depleted stream SD may contain other chemicals in addition to those listed above, and/or the constituents may be present in the solids-depleted stream SD in different concentrations. The solids-depleted stream SD may be a centrate stream, while the solids rich stream SR may be a bio-solids cake.

Because the alkali earth metals (e.g., calcium) dissolved in the solids-depleted stream SD are soluble while in the bicarbonate form, these alkali earth metals are removable from the solids-depleted stream SD by lime or soda-lime softening (increasing the pH of the solids-depleted stream SD to form a more basic solution). The solids-depleted stream SD is introduced into a lime softener reactor and settler apparatus 25, which includes one or more reaction chambers 5, one or more flocculation chambers 6, and one or more settling chambers 7, the solids-depleted stream SD in a preferred embodiment flowing through these chambers 5, 6, and 7 in that order as shown in FIG. 1. The lime softener reactor and settler apparatus 25 precipitates calcium carbonate and forms and precipitates calcium phosphate, magnesium ammonium phosphate, and/or struvite as well as converts the ammonium ion into ammonia. The conversion of ammonium bicarbonate to free ammonia and calcium carbonate is shown in the following reaction:

NH₄⁺+HCO₃⁻+Ca(OH)₂→NH₄⁺+CaCO₃₍ₛ₎+H₂O

The solubilities of several alkali earth salts are shown in Table 2:

TABLE 2

| Alkali Earth Salt Compound | Solubility (grams/100 g water) |
|---|---|
| CaCO₃ | 0.00066 |
| Ca₃(PO₄)₂ | 0.00012 |
| CaSO₄ | 0.205 |
| Ca(OH)₂ | 0.16 |
| MgCO₃ | 0.18 |
| Mg₃(PO₄)₂8H₂0 | 0.00009 |
| MgSO₄ | 35.7 |
| Mg(OH)₂ | 0.00069 |

An inherent challenge with using lime-based products is that calcium hydroxide is only sparingly soluble in water as demonstrated in the above table and must dissolve before the reactions needed to raise the pH and cause precipitation occur. This challenge is mitigated by making milk of lime and by using finely divided material with small calcium hydroxide particles. Using the lime softener reactor and settler apparatus 25 and its associated method, the bulk of the precipitation occurs on the previously-formed particles rather than the walls of the container. Embodiments of the present invention involve enclosing the lime softener reactor and settler apparatus 25 (essentially lined lagoons).

A device and method usable as at least a portion of the lime softener reactor and settler apparatus 25 is shown and described in U.S. Pat. No. 4,209,395 issued Jun. 24, 1980, which is herein incorporated by reference in its entirety. In this patent, by recycling a stream containing a high percentage of crystallized solid particles to serve as nucleation sites for additional crystal growth, super-saturation of calcium carbonate is avoided and the alkali earth ions may be precipitated from the solution. Depending upon the composition of the waste stream, additional soda ash may be added as a source of carbonate ion and to further raise the pH of the resulting stream. The recirculation of the particles also helps reduce mineral deposit on the surfaces of the equipment. The system and recirculation rate is designed such that the available surface area of the recycled particles is substantially greater than the equipment surface area, minimizing precipitation on equipment surfaces. In farm and concentrated animal applications where space is more generally available, a multi-chambered lined and covered lagoon may be utilized to accomplish this same result. However, the above-referenced patent does not allow for or address ammonia removal.

The embodiment of FIG. 1 allows for ammonia removal in addition to phosphorus and alkali earth metals removal. As shown in FIG. 1, in the one or more reaction chambers 5, the solids-depleted stream SD is reacted with lime L (or soda lime), which is introduced into the reaction chamber(s) 5 from a lime storage tank 4. The lime stream L may utilize calcium oxide (e.g., a slaked lime such as calcium carbonate CaCO₃) and/or calcium hydroxide (quick lime, CO₃) to minimize the use of salt (sodium chloride), soda ash, or caustic soda, especially where the treated water is discharged into fresh water or applied to soils where minimal salt content in the treated water is desirable. A further advantage to the use of the lime L rather than the soda ash or caustic soda is that nearly all forms of lime, including quick lime and slaked lime, are much less costly on a chemical equivalent basis than caustic soda or soda ash. However, it is within the scope of embodiments of the present invention that caustic soda or soda ash may be utilized in addition to or in lieu of the lime L to increase the pH of the solids-depleted stream SD.

In addition to adding lime L and the solids-depleted stream SD to the reaction chambers 5, a compressed gas G such as nitrogen, air, carbon dioxide, biogas, or mixtures of one or more of these gases is added to the reaction chambers 5 to generate bubbles, thereby providing agitation in the reaction chamber(s) 5 to allow for ammonia removal from the solids-depleted stream SD. The gas G may be compressed using a compressor 16 or a blower. (In an alternate embodiment, the contents of the reaction chamber(s) 5 are agitated by fluid pumping into the chamber(s) 5 in lieu of or in addition to the compressed gas G, and the unit 16 is a liquid pump.) Optionally, the gas G may be heated after its compression, for example using an optional gas heater 12. Heating the gas G allows the use of a heat exchanger that does not directly contact the liquid stream, which avoids fouling of the heat exchanger from the precipitating particles in the liquid stream. In the reaction chamber(s) 5, the gas bubbles agitate the liquid stream flowing through the reaction chamber(s) 5 and, when the gases contain oxygen, assist in the conversion of ferrous to ferric ions. Additionally, the dissolving lime converts ammonium ion into ammonia which may escape into the sparged gas from the settling chamber(s) 7 to form ammonia-laden gas GA. The engineered vessel for the lime softener reactor and settler apparatus 25 is preferably entirely enclosed and maintained under a slight vacuum. The agitated gas or liquid is added to the reaction chamber(s) 5 may be enough gas/liquid to use the lime L to precipitate out the phosphorous, but not so much gas/liquid that it removes the bulk of the ammonia at the same time.

Because the bulk of the precipitate-forming solids are precipitated out in the lime softener reactor and settler apparatus 25, there is advantageously no (or at least negligible) precipitant formation, such as struvite or magnesium formation, on the walls of or in any of the downstream piping or equipment of treatment steps occurring after the lime softener reactor and settler apparatus 25. When the solids are not precipitated out upstream of the treatment equipment and piping of the nutrient recovery process, the piping and equipment of the ammonia recovery process and/or the piping or equipment conveying the treated waste stream back to the plant may become damaged or clogged due to the formation of these solids on the walls or other portions of the piping and/or equipment, reducing efficiency of the nutrient recovery system and increasing the cost of the nutrient recovery process.

The ammonia-laden gas GA may be scrubbed with an acidic solution to remove the ammonia, which scrubbing may be accomplished using one or more scrubbers, for example one or more acid scrubbers 8, neutral scrubbers 9, and/or caustic scrubbers (not shown). Unless the chemistry of the waste treated demands the use of a caustic scrubber, the preferred embodiment includes scrubbing the ammonia-laden gas GA using at least one acid scrubber 8 followed by at least one neutral scrubber 9. The acid scrubber 8 uses an acidic solution to absorb gaseous ammonia into an acid stream, while the neutral scrubber 9 utilizes a neutral solution to protect the compressor/blower 16 from acidic carryover from the acidic scrubber 8.

The carrier gas G may be recirculated back into the reaction chamber(s) 5 for re-use, or in the alternative, the carrier gas G may be vented, as meets the specific design objectives of the system. Recycling the gas back into the lime softener reactor and settler apparatus 25 greatly diminishes the need for and the required sizes of subsequent odor control equipment. Where the gas G contains carbon dioxide (CO₂), a portion of this carbon dioxide would likely react with dissolved calcium in the apparatus 25, thereby advantageously further enhancing precipitation. Passing the ammonia-laden gas GA through the one or more scrubbers 8, 9 permits effective re-use of the gas G.

As the acidic scrubber solution becomes saturated with ammonium salt, portions of the acidic solution 29 may proceed to product recovery by exiting the acidic scrubber 8 and entering a product recovery tank 18. In one embodiment, the acidic scrubber 8 utilizes sulfuric acid (H₂SO₄), and the acidic solution of ammonium salt 29 which enters the product recovery tank 18 is ammonium sulfate ((NH₄)₂SO₄).

Optionally, fresh concentrated acid (e.g., sulfuric acid) and liquid from the neutral wash 9 may provide make-up solution to the acid scrubber 8, while fresh water may provide make-up solution to the neutral scrubber 9. By providing the make-up solution(s), potential corrosion in the compressor 16 is limited or eliminated so that a liquid ring compressor is usable if desired. Also optionally, to mitigate hydrogen sulfide build-up after the ammonia-laden gas GA exits the acid scrubber 8, iron fillings and/or colloidal iron may be added and/or a caustic scrubber may be used to further scrub the solution after the ammonia-laden gas GA exits the acid scrubber 8. Other optional methods for treating both the hydrogen sulfide and volatile organic compounds that could be carried into the scrubber include the addition of hydrogen peroxide and/or soluble iron (which may include Fenton's Reagent).

After the lime stream L is reacted with the solids-depleted waste stream SD, agitated with the gas G, and the chemical reaction is complete within the reaction chamber(s) 5, the resulting solution exits the reaction chamber(s) 5 and enters into the one or more flocculation chambers 6. Due to the addition of the lime feed L to the reaction chamber(s) 5, the solution 26 entering into and present within the flocculation chamber(s) 6 has a higher pH than the pH of the solids-depleted stream SD, preferably a basic pH, most preferably a pH of approximately 10.5 to approximately 11.

Calcium bicarbonate is highly soluble in water and the lime and soda-lime softening process works by raising the solids-depleted stream SD pH to a point at which the bicarbonate anion is converted to the carbonate ion (this point of conversion typically occurs at an increased pH of approximately 10.5 to approximately 11). When the conversion of the bicarbonate anion to the carbonate ion occurs, calcium carbonate, which is highly insoluble in water, precipitates into a solid, and a variety of other minerals such as calcium phosphate, magnesium ammonium phosphate, and/or struvite will form and precipitate.

In the flocculation chamber(s) 6, one or more flocculants F are added to the reacted solution which exits from the reaction chamber(s) 5 to form solution 26, and the precipitates are flocculated. After adding the flocculant(s) F to the flocculation chamber(s) 6, the solution 26 enters the one or more settling chambers 7, where the precipitates are settled.

The one or more flocculants may include any flocculant or flocculation agent known to those skilled in the art, including but not limited to salts containing trivalent metal ions such as FeCl₃ or any flocculation agent mentioned in the disclosure of the '395 patent incorporated by reference above. Furthermore, the reaction chamber(s) 5, flocculation chamber(s) 6, and/or settling chamber(s) 7 may be configured and may operate in the same manner as the reaction zone, flocculation zone, and sedimentation/filtration zone, respectively, shown and described in the '395 patent, with the variations to the process/devices described herein. The soda lime softening process may be the same as or similar to the process described in the '395 patent with the variations to the process as described herein. The variations described herein may include the gas agitation.

At some point after the particles exit the settling chamber(s) 7, the settled liquid enters a vacuum stripping unit or vacuum stripper 19 (or ammonia absorption column), where the ammonia is removed as a gas 33, particularly in a higher-ammonia discharge or land application case where the settled liquid is a high-pH settled liquid. (In one embodiment, the soda lime softening effluent 28 may be sent directly to the vacuum stripper 19 without flowing the effluent 28 through the equipment in box 30 and without the additional process steps performed by the equipment in box 30.) Although it is possible to use an air stripper with embodiments of the present invention in addition to or in lieu of the vacuum stripper, the vacuum stripper in combination with the front end treatment (e.g., the lime softener reactor and settler 25 and/or the air agitation, scrubbing, and/or other process steps prior to the entry of the solution into the vacuum stripper) has proven more effective in efficiently recovering concentrated ammonia streams than the use of an air stripper and ammonia absorber column combination.

The ammonia gas 33 may enter a venturi recirculation line 35 and be pumped by pump 21 into the product tank 18. Ultimately, the ammonia gas 33 is captured in a concentrated ammonium salt and acid solution, which capturing may occur in the product tank 18. Flowing into the product tank 18 are the ammonia gas 33 (or 35), the portion of acidic solution 29 exiting from the acid scrubber 8, and an acid stream 36. The acid stream 36 may flow from an acid supply tank 17. Also, optionally, a spent-regeneration solution 37 may be recycled into the product tank 18, as described in more detail below in relation to the “optional devices and additional process steps.” In one embodiment, the acid (supplied by tank 17) is sulfuric acid, and the product tank 18 includes ammonium sulfate ((NH₄)₂SO₄) due to the mixing of the streams 33 (or 35), 29, 36, and optionally the stream 37. Embodiments link the acid scrubber acid solution 29 and the vacuum stripper absorption solution 33 to form a single product of ammonium sulfate or other ammonium salt solution, preferably approximately 40% ammonium sulfate or equivalent other ammonium salt solution (but other ammonium salt product concentrations are within the scope of embodiments of the present invention).

The portion of the solution exiting the vacuum stripper 19 which is not removed as a gas 33 is an at least partially-treated centrate stream 34. This centrate stream 34 may be further treated by the optional equipment in box 31, but eventually enters the treated water neutralization tank 24 if pH adjustment is necessary or desired, where the centrate stream 34 is neutralized using caustic by caustic stream 40 (which may be supplied from caustic tank 20) and/or acid via acid stream 41 (which may be supplied from acid tank 17). The treated water T may then be returned to the wastewater plant or otherwise discharged from the system. The caustic as well as the acid (which may be sulfuric acid) may be utilized to neutralize the water, preferably modifying the pH of the centrate stream 34 from approximately 10.5 to approximately 6 to approximately 8 (the pH of the treated water T is preferably at least substantially neutral, most preferably having a pH value of approximately 6 to approximately 8).

In other alternate embodiments, no pH adjustment is performed on the centrate stream 34 (the treated main-flow stream). If necessary or desired, the pH adjustment may be performed in any manner known to those skilled in the art. In any event, the treated water T may be sent to the irrigation field, applied to land or soil, discharged into fresh water or salt water, stored, and/or returned to the plant.

Several optional devices and additional process steps which are shown in FIG. 1 may be utilized in embodiments where it is desired to reduce the effluent ammonia concentration to below approximately 200 ppm (although their use in other applications to obtain other ammonia concentrations is also within the scope of embodiments of the present invention). These optional devices and method steps are depicted within the dotted-line boxes 30 and 31. Specifically, the optional devices include one or more multi-media filters 13, one or more cartridge filters 14, one or more cation exchange softeners or ion exchange columns 15, 22, and associated tanks 23 and pumps (not shown). Ion exchange and the ion exchange process is shown and described in “Ion Exchange Primer,” pages 1-12, distributed by Sybron Chemicals, Inc., which is herein incorporated by reference in its entirety. Any of the ion exchange principles, resins, equipment, and operations described in the “Ion Exchange Primer” may be utilized in any of the embodiments of the present invention.

In ammonia waste cases where ammonia concentrations are very high, the optional equipment shown in boxes 30 and 31 and the process steps performed by this equipment may not be required and therefore may be eliminated. Especially where the effluent water is to be land-applied, these additional devices 30 and 31 and their associate process steps may be omitted. The devices may only be required where the effluent ammonia must be reduced to a concentration of below approximately 200 ppm, because the vacuum stripper 19 is capable of competently handling a reasonable level of suspended solids.

Where it is desired to remove the ammonia concentration to a few parts per million, some or all of the equipment of boxes 30 and 31 and some or all of the processes performed by the equipment of boxes 30 and 31 may be necessary. When the equipment and/or process steps designated in boxes 30 and 31 are utilized, the settling device (the settling chamber) 7 may be sized appropriately and its parameters optimized so that the concentration of suspended solids in the settled liquid 28 is in a range suitable for subsequent treatment in a polishing filter such as the shown multi-media filter 13. Of course, any other type of polishing filter device or method of filtering (and the associated equipment) known to those skilled in the art may be utilized in lieu of or in addition to the multi-media filter 13.

The equipment depicted in boxes 30 and 31 operate in the following manner when utilized. The settled liquid high-pH solution (for example, having a pH of approximately 10.5) flows into the multi-media filter 13 (and/or other polishing filter). The backwash or overflow from the multi-media filter 13 may be recirculated back into the system 25, specifically back into one or more of the reaction chambers 5, as overflow stream 43. Preferably, the overflow stream 43 is recycled back to the front of the soda-lime softener 25.

The remainder of the product from the multi-media filter 13 (probably a high-pH solution) flows as stream 44 to a cartridge filter 14 for further filtering of the solution 44. As in the multi-media filter 13, the cartridge filter 14 may be supplemented or eliminated, as desired, and other filters having similar functions known to those skilled in the art may be utilized instead of the cartridge filter 14.

The cartridge-filtered stream 45 then flows into an ion exchange column 15, which may be a cation exchange softener. The ion exchange column 15 removes the remaining divalent and trivalent cations from the stream 45. The ion exchange column 15 may be a standard ion exchange column as known to those skilled in the art, and it may be regenerated with sodium chloride (salt) brine and/or with a concentrated ammonium chloride solution (and/or with sodium hydroxide, sodium chloride, brine, or a combination thereof). The ammonium chloride solution is obtainable from the acid scrubber 8, and hydrochloric acid (HCl) may be utilized as the acid. The rationale for the use of the chloride is that calcium chloride, which is being removed from the column, is highly soluble. When simplicity is desirable, salt brine may be utilized for this purpose.

Upon its exit from the ion exchange column 15, the stream 32 (may be a high-pH stream) enters the vacuum stripper 19 described above. In this embodiment as well as the embodiments where the equipment/processes of boxes 30 and 31 are eliminated, the vacuum stripper unit 19 removes ammonia gas 33 from the stream 32. After the vacuum stripping step, the concentration of residual ammonia in the liquid stream 34 may be approximately 100 ppm to approximately 250 ppm. Because it leaves the water stream as a gas, the ammonia gas 33 is at least substantially void of other metal cations upon its leaving of the water stream. The ammonia gas 33 may include one or more volatile organics and/or some sulfides, in which case it may be treated as mentioned previously in paragraph [0030] above.

The centrate stream 34 may optionally be sent to the equipment shown in box 31, specifically one or more ammonia polishing columns/ion exchange systems 22 to remove any remaining ammonia and/or potassium. A variety of possible columns and resins may be utilized in this ammonia polishing step, including one or more weak acid resins which remove ammonia as ammonia and/or one or more strong acid cation resins which convert ammonia to ammonium ion and remove it as an ion. A strong acid cation resin in the hydrogen form would recover both the potassium and ammonium. The centrate stream 34 may be regenerated with sulfuric acid, preferably approximately 8% sulfuric acid, and the spent regeneration solution may then be sent to the venturi feed tank where it would be used in the vacuum stripping section.

By the use of embodiments described above, the resulting main process flow stream of treated water T is closer to neutral pH and contains low or minimal amounts of ammonia, calcium, suspended solids, phosphorous, potassium, and/or other nutrients, thereby allowing re-use of the treated stream T in a variety of applications or disposal or storage thereof.

The above-described devices and methods are especially useful when treating animal wastes where the concentration of ammonia can easily be as high as 8,000 ppm. Table 3 shows the equilibrium of the ammonium ion and ammonia as a function of pH for a solution that contains approximately 1,000 ppm of ammonia as nitrogen (values are for 90° F. and are approximate):

TABLE 3

| | | 1,000 ppm N Total | |
|---|---|---|---|
| [OH] ppm | pH Centrate | NH3—N ppm | ppm NH4+—N ppm |
| 0.10 | 7 | 10 | 990 |
| 10 | 9 | 494 | 506 |
| 16 | 9.2 | 608 | 392 |
| 25 | 9.4 | 711 | 289 |
| 40 | 9.6 | 796 | 204 |
| 63 | 9.8 | 860 | 140 |
| 100 | 10 | 907 | 93 |
| 158 | 10.2 | 939 | 61 |
| 251 | 10.4 | 961 | 39 |
| 398 | 10.6 | 975 | 25 |
| 631 | 10.8 | 984 | 16 |
| 1,000 | 11 | 990 | 10 |
| 1,585 | 11.2 | 994 | 6 |
| 2,512 | 11.4 | 996 | 4 |
| 3,981 | 11.6 | 997 | 3 |
| 6,310 | 11.8 | 998 | 2 |
| 10,000 | 12 | 999 | 1 |
| 15,849 | 12.2 | 999 | 1 |

Because lime addition is capable of achieving a stream pH of approximately 10.5 and this pH is capable of converting the bulk of both the bicarbonate anions in solution to carbonate and the ammonium cations to ammonia, significant cost savings are available with the use of lime in place of soda ash or caustic soda. For instance, in this example, presume that the lime was used to raise the pH to 10.5 and then caustic was used to raise the pH from 10.4 to 10.6. Also presume that the concentration of bicarbonate was the same as ammonium ion and that all of the bicarbonate was converted to carbonate by lime at pH 10.4. It may be desirable to raise the pH to 10.6 to precipitate the residual magnesium hydroxide as well as further convert ammonium ion to ammonia. The amount o hydroxyl ion contributed by the caustic would be 398 ppm−251 ppm=147 ppm for the solution pH plus 39 ppm−25 ppm=14 ppm for the ammonium conversion for a total of 147+14=161 ppm of hydroxyl ion. Assuming that there are roughly the same equivalents of bicarbonate as there are ammonium ions, the lime would be supplying −2,200 ppm of hydroxyl ion versus 161 ppm for the caustic at the titration end point. With animal wastes, the high concentration of ammonia and bicarbonate makes the use of lime even more vitally important because lime is much less costly than caustic and much easier to handle and store.

Before being placed into service in the system, wetted surfaces may be cleaned and/or coated with a film of water repellent and/or one or more chemical-resistant materials such as silicone, Teflon®, and/or hydrocarbon-based grease. The chemical-resistant materials minimize the ability of precipitate scale to form on equipment surfaces and facilitate cleaning of the equipment if precipitation did occur.

In any of the above-described embodiments, some or all of the gas bubbles may be introduced into the lime softener reactor and settler apparatus 25 as one or more high-velocity jet streams to induce a higher shear rate of ammonia-laden gas from the waste stream W. This higher shear rate may increase system efficiency in the removal of ammonia as well as other nutrients from the waste water W.

With the above-described ammonia recovery process, the product ammonium sulfate may be utilized as a commercial grade fertilizer. The nitrogen in the form of ammonia found in the waste stream is thereby efficiently and cost-effectively converted to a usable product by use of the above-described methods and apparatus. The recovery of ammonia in the form of ammonium sulfate or in any other form using the above-described methods and apparatus advantageously limits nitrogen discharge into bodies of water, as often required by environmental regulations, along with providing a usable end-product (e.g., ammonium sulfate).

The above-described nutrient recovery method advantageously involves introducing gas bubbles while mixing the lime or lime-based solution into the waste stream feed, thereby stripping ammonia from the waste stream feed. At the same time, the above-described process enhances precipitation of phosphorous from the waste stream feed. Accordingly, both ammonia recovery and phosphorous recovery are accomplished efficiently and cost-effectively upon the introduction of gas bubbles into the system 25.

Moreover, the above-described nutrient recovery method combines front-end treatment of the waste stream with vacuum stripping, also enhancing nutrient recovery from the waste stream.

In any of the above embodiments, the brine may be substituted with sodium hydroxide, sodium chloride, brine, or a combination or solution thereof.

While the foregoing is directed to embodiments of the present invention, other and further embodiments of the invention may be devised without departing from the basic scope thereof, and the scope thereof is determined by the claims that follow.

1. A method of recovering ammonia and precipitating phosphorous from a waste stream, comprising:
separating an anaerobically digested waste stream into a solids-rich stream and an solids-depleted stream;
reacting the solids-depleted stream with lime or a lime-based solution to form a first mixture;
introducing compressed gas into the first mixture to form an aerated first mixture;
passing the aerated first mixture through a reaction zone;
passing the aerated first mixture stream through a flocculation zone, where a flocculation agent is added to the aerated first mixture to form a second mixture;
passing the second mixture stream through a settling zone, thereby removing precipitated settled solids from the second mixture stream and removing an ammonia-laden gas and a softened solids-depleted stream from the second mixture stream via sparged compressed gas;
scrubbing the ammonia-laden gas using an acidic solution to remove ammonia therefrom; and
passing at least a portion of the softened solids-depleted stream through at least one ammonia absorption column to remove ammonia therefrom,
wherein introducing the compressed gas into the first mixture removes ammonia and enhances phosphorous precipitation.

2. The method of claim 1, wherein the lime or lime-based solution comprises calcium hydroxide, calcium oxide, or a combination thereof.

3. The method of claim 1, wherein the lime or lime-based solution comprises finely-divided crystalline calcium carbonate [CaCO₃] particles, milk of lime [Ca(OH)₂], lime-water, or a combination thereof.

4. The method of claim 1, wherein the reaction zone, flocculation zone, and settling zone are disposed in an enclosed vessel maintained under a vacuum.

5. The method of claim 1, wherein scrubbing the ammonia-laden gas using the acidic solution is accomplished using an acid scrubber.

6. The method of claim 5, further comprising:
recovering as ammonium salt product a first portion of scrubbed, ammonia-laden gas from the acid scrubber when the first portion becomes saturated with ammonium salt.

7. The method of claim 6, further comprising scrubbing a second portion of the ammonia-laden gas exiting the acid scrubber using a neutral solution; and
recycling the second portion of the ammonia-laden gas into the reaction zone.

8. The method of claim 7, further comprising compressing the second portion of the ammonia-laden gas prior to its recycling into the reaction zone.

9. The method of claim 8, further comprising heating the second portion of the ammonia-laden gas prior to its recycling into the reaction zone.

10. The method of claim 1, further comprising passing the at least a portion of the softened solids-depleted stream through one or more filters before passing the at least a portion of the softened solids-depleted stream through the at least one ammonia absorption column.

11. The method of claim 10, wherein the one or more filters comprise one or more multi-media filters and one or more cartridge filters.

12. The method of claim 10, wherein:
a first portion of the softened solids-depleted stream passing from the one or more filters is passed to the at least one ammonia absorption column; and
a second portion of the softened solids-depleted stream passing from the one or more filters is recycled to the reaction zone.

13. The method of claim 10, further comprising passing the at least the portion of the softened solids-depleted stream through one or more cation exchange softeners after passing the at least a portion of the softened solids-depleted stream through the one or more filters and before passing the at least a portion of the softened solids-depleted stream through the at least one ammonia absorption column.

14. The method of claim 1, further comprising:
passing a first portion of the at least a portion of the softened solids-depleted stream exiting from the at least one ammonia absorption column into ammonium salt product recovery, the first portion comprising ammonia vapor; and
neutralizing a second portion of the at least a portion of the softened solids-depleted stream exiting from the at least one ammonia absorption column to recover a treated product stream.

15. The method of claim 14, further comprising:
passing the second portion of the at least a portion of the softened solids-depleted stream through one or more ion exchange columns prior to neutralizing the second portion to remove remaining ammonia and potassium therefrom; and
sending the removed ammonia to ammonium salt product recovery.

16. The method of claim 14, wherein the softened solids-depleted stream has a pH of approximately 10.5, and wherein the treated product stream has a pH of from approximately 6 to approximately 8.

17. The method of claim 16, wherein the pH of the solids-depleted stream is approximately 7.

18. The method of claim 1, wherein the compressed gas comprises a plurality of gas bubbles, a first portion of the gas bubbles jetted at a higher velocity than a second portion of the gas bubbles.

19. The method of claim 1, further comprising optimizing a jetting velocity of compressed gas bubbles to induce a desired shear rate of ammonia from the waste stream.

20. An apparatus for removing ammonia and phosphorous from a waste stream, comprising:
a reacting and settling vessel comprising:
at least one reaction chamber for reacting a lime or lime-based product with a solids-depleted stream,
at least one flocculation chamber for adding a flocculating agent to the solids-depleted stream,
at least one settling chamber for settling and precipitating a solids stream from an ammonia-laden gas, and
a capability to recirculate at least a portion of settled solids back to the at least one reaction chamber;
at least one gas compressor for compressing a gas prior to its introduction into the at least one reaction chamber; and
at least one ammonia absorption column for separating ammonia from the compressed gas subsequent to its contact in at least one of the chambers of the reacting and settling vessel, wherein the compressed gas removes ammonia from the solids-depleted stream and enhances phosphorous precipitation.

21. The apparatus of claim 20, further comprising one or more filtering devices located downstream from the reacting and settling vessel and upstream from the at least one ammonia absorption column.

22. The apparatus of claim 21, wherein the one or more filtering devices comprise one or more multi-media filters.

23. The apparatus of claim 22, wherein the one or more filtering devices further comprise one or more cartridge filters.

24. The apparatus of claim 20, further comprising one or more ion exchange softening columns located downstream from the reacting and settling vessel and upstream from the at least one ammonia absorption column.

25. The apparatus of claim 20, further comprising one or more ammonia polishing columns disposed downstream of the at least one ammonia absorption column.

26. The apparatus of claim 20, further comprising one or more scrubbing devices disposed downstream from the reacting and settling vessel for acid scrubbing an ammonia-laden gas removed from the reacting and settling vessel.

27. The apparatus of claim 26, wherein the one or more scrubbing devices comprise one or more acid scrubbers.

28. The apparatus of claim 27, wherein the one or more scrubbing devices further comprise one or more neutral scrubbers.

29. A method for slow softening a waste stream having soluble calcium compounds present therein, wherein at least one alkaline precipitating agent is admixed with the waste stream to be softened in a mixing zone and then the calcium compounds are changed inside a reaction zone through which the waste stream passes after being admixed with the alkaline precipitating agent into insoluble calcium carbonate matter which is subsequently changed in a flocculation zone into settleable flocs by the addition of a flocculating agent containing trivalent metal ions, comprising:
(1) mixing the waste stream, the alkaline precipitating agent, and an agitated liquid, gas, or combination of liquid and gas with finely divided crystalline calcium carbonate in the mixing zone prior to the addition of and in the absence of the flocculation agent to form seeds for the calcium carbonate matter which newly precipitates from the waste stream inside the reaction zone;
(2) presettling and discharging at least a part of the insoluble calcium carbonate matter which has been precipitated inside the reaction zone;
(3) passing the waste stream into a flocculating zone, wherein the waste stream is mixed with the flocculating agent; and
(4) passing the waste stream into a sedimentation zone.

30. The method of claim 29, wherein separated products exiting from the sedimentation zone comprise precipitated solids, a softened waste stream, and ammonia-laden gas.

31. The method of claim 30, further comprising recycling the ammonia-laden gas into the mixing zone to act as the agitated liquid, gas, or combination of liquid and gas in step (1).

32. The method of claim 30, further comprising:
(5) removing ammonia from the softened waste stream using at least one ammonia absorption column.

33. The method of claim 29, wherein at least 5 g/m³ of the finely divided calcium carbonate is added to the mixing zone in step (1).

34. The method of claim 29, wherein the waste stream is wastewater.

35. The method of claim 29, wherein the agitated liquid, gas, or combination of liquid and gas is a compressed gas.

36. The method of claim 35, wherein the compressed gas comprises one or more gas bubbles.

37. The method of claim 29, wherein the mixing zone, flocculation zone, and sedimentation zone are disposed in an enclosed vessel maintained under a vacuum.

38. The method of claim 29, further comprising anaerobically digesting the waste stream prior to step (1).
